(19) United States
(12) Patent Application Publication
(10) Pub. No.: US 2024/0149867 A1
(43) Pub. Date: May 9, 2024

(54) PARKING ASSISTANCE DEVICE AND PARKING ASSISTANCE METHOD

(71) Applicant: TOYOTA JIDOSHA KABUSHIKI KAISHA, Toyota-shi (JP)

(72) Inventors: Takuya NAKAGAWA, Nagoya-shi (JP); Yohei SUZUKI, Tokyo-to (JP); Yoshiki HAYAKAWA, Kariya-shi (JP)

(73) Assignee: TOYOTA JIDOSHA KABUSHIKI KAISHA, Toyota-shi (JP)

(21) Appl. No.: 18/466,393

(22) Filed: Sep. 13, 2023

(30) Foreign Application Priority Data
Nov. 8, 2022 (JP) 2022-178722

(51) Int. Cl. B60W 30/06

(52) U.S. Cl. CPC B60W 30/06

(57) ABSTRACT

A parking assistance device 1 assisting an operation to park an own vehicle in a parking spot PS, and/or an operation to exit the own vehicle from the parking spot PS, comprises a surrounding sensor 20 to acquire information about objects existing around the own vehicle and a processor capable of executing parking assistance control to assist driving operation by the driver, by setting a target position TP based on the information acquired by the surrounding sensor 20, further setting a target route TR to reach the target position, and controlling the own vehicle to automatically move along the target route TR and reach the target position TP.

The processor is configured to set the target route as a route that can reach the target position without making contact with all the first objects, which are determined to obstruct the progress of the own vehicle, and all the second objects, which are determined to be unclear whether or not they obstruct the progress of the own vehicle.

### BACKGROUND OF THE INVENTION

The present invention relates to a parking assistance device that assists in the operation of driving an own vehicle into a parking spot and/or driving the own vehicle out of a parking spot.

### DESCRIPTION OF THE RELATED ART

A parking assistance device has been proposed for assisting in the operation of driving an own vehicle out of a parking spot (for example, see Japanese Patent Application Laid-open No. 2019-123535). This type of parking assistance device, referred to as a “conventional device” hereinafter, includes surrounding sensors and a processor. The surrounding sensors include sensors (e.g., ultrasonic sensors, cameras, etc.) that acquire information about objects existing around the own vehicle. The processor recognizes obstacles, i.e., objects that obstruct the movement of the own vehicle, based on the information acquired by the surrounding sensors. The processor sets a target position where the own vehicle can be stopped without contacting the recognized objects and sets a target route that allows the own vehicle to move without contacting the recognized objects (excluding temporarily touchable objects such as parking lines) to reach the target position. The processor controls the own vehicle's driving device, braking device, steering device, and the like to move the own vehicle along the target route and reach the target position.

### SUMMARY

The processor of the conventional device acquires physical quantities related to each object based on information (object features) obtained from the surrounding sensors and determines whether each object obstructs the own vehicle's movement. The process of this determination is referred to as “obstacle determination process.” In other words, when the physical quantity related to an object exceeds a threshold value, the processor determines that the object obstructs the own vehicle's movement. That is, the processor determines that the object corresponds to an obstacle. On the other hand, when the physical quantity related to an object is equal to or below the threshold value, the processor determines that the object does not obstruct the own vehicle's movement. That is, the processor determines that the object does not correspond to an obstacle.

However, there are cases where the amount of information obtained by the surrounding sensors is insufficient. Also, the accuracy (precision) of the information obtained by the surrounding sensors, the computational accuracy of the processor, and the like may be low. Therefore, there are cases where the accuracy (precision) of the physical quantity acquired by the processor is low, and the processor mistakenly determines that an object that should be judged as an obstacle does not correspond to an obstacle.

For example, when the height of an object (height difference from the road surface) exceeds a threshold value, the processor sets a target route to avoid (detour) the object. On the other hand, when the height of the object is equal to or below the threshold value, the processor sets a target route assuming that the object does not exist. In this case, for example, even if the actual height of a snow pile near the parking spot slightly exceeds the threshold value, there may be cases where the height of the snow pile obtained by the processor is slightly lower than the threshold value. In this case, the processor sets a target route assuming that the snow pile does not exist. As a result, there is a risk that the own vehicle may come into contact with the snow pile during the course of the own vehicle's movement.

As described above, when the physical quantity of an object obtained by the processor is close to the threshold value in the obstacle determination process, there is a risk of mistakenly determining that the object does not correspond to an obstacle and setting a target route that passes through the area occupied by the object. Therefore, there is room for improvement in terms of safety of the own vehicle.

One of the objectives of the present invention is to provide a parking assistance device that can improve safety.

To achieve the above objectives, a parking assistance device (1) assisting an operation to park an own vehicle (V) in a parking spot (PS), and/or an operation to exit the own vehicle from the parking spot, comprises;
a surrounding sensor (20) to acquire information about objects existing around the own vehicle; and
a processor (10) capable of executing parking assistance control to assist driving operation by the driver, by setting a target position (TP) based on the information acquired by the surrounding sensor, further setting a target route (TR) to reach the target position, and controlling the own vehicle to automatically move along the target route and reach the target position.

The processor is configured to set the target route as a route that can reach the target position without making contact with all the first objects (OB1), which are determined to obstruct the progress of the own vehicle, and all the second objects (OB2), which are determined to be unclear whether or not they obstruct the progress of the own vehicle.

Accordingly, the processor sets a route as the target route that allows the own vehicle to reach the target position without contacting not only the first objects determined as obstacles but also the second objects where it is undetermined whether they are obstacles. Therefore, compared to the conventional device that may erroneously determine that the second objects do not correspond to obstacles, the present invention can improve safety.

In another aspect of the parking assistance device according to the present invention, if there is no route that allows the own vehicle to reach the target position without contacting any of the first objects and any of the second objects, the processor is configured to set a route as the route that enables the own vehicle to reach the target position without contacting any of the first objects, and allows the own vehicle to pass through an area occupied by one or more of the second objects.

The second objects may not actually correspond to obstacles. However, if all the second objects are regarded as obstacles, the processor cannot set a target route, and as a result, there is an extremely limited opportunity for the driver to take advantage of the assistance from the parking assistance device. According to this aspect, since it is permitted for the own vehicle to pass through the area occupied by the second objects, the driver can take advantage of the assistance from the parking assistance device while being aware of those second objects.

In another aspect of the parking assistance device according to the present invention, the parking assistance device further comprises a presentation unit that presents information indicating that the own vehicle is expected to pass through an area occupied by the second objects.

Accordingly, the driver's attention to the second objects can be drawn.

In another aspect of the parking assistance device according to the present invention, the processor is configured to set the target position based on the front end position of another vehicle parked adjacent to the parking spot when the other vehicle is parked parallel to the own vehicle.

Accordingly, the processor can set the own vehicle's front-to-back position based on other vehicles.

Further, a driving assistance method according to the present invention includes steps performed by each device constituting the above-described driving assistance device.

### BRIEF DESCRIPTION OF THE DRAWINGS

FIG. 1 is a block diagram of a parking assistance device according to an embodiment of the present invention.

FIG. 2A is a first example of a map at the start point (t0) of automatic parking control.

FIG. 2B is a second example of a map at the start point (t0) of automatic parking control.

FIG. 3A is a first example of a map at an intermediate point (t1) of automatic parking control.

FIG. 3B is a second example of a map at an intermediate point (t1) of automatic parking control.

FIG. 3C is a third example of a map at an intermediate point (t1) of automatic parking control.

FIG. 4 is a flowchart of a program for realizing automatic parking control.

FIG. 5 is a flowchart of a program for updating a target position.

FIG. 6 is a flowchart of a program for updating a target route.

### DESCRIPTION OF THE EMBODIMENTS

### Summary

A parking assistance device 1 according to an embodiment of the present invention is installed in a vehicle V (referred to as “own vehicle” hereinafter) equipped with autonomous driving capability. The parking assistance device 1 has a function (automatic entry assistance function) that executes entry assistance control to assist in driving the own vehicle into a parking spot. Furthermore, the parking assistance device 1 has a function (automatic exit assistance function) that assists in driving the own vehicle out of the parking spot. Entry assistance control and exit assistance control are sometimes referred to as “parking assistance control”.

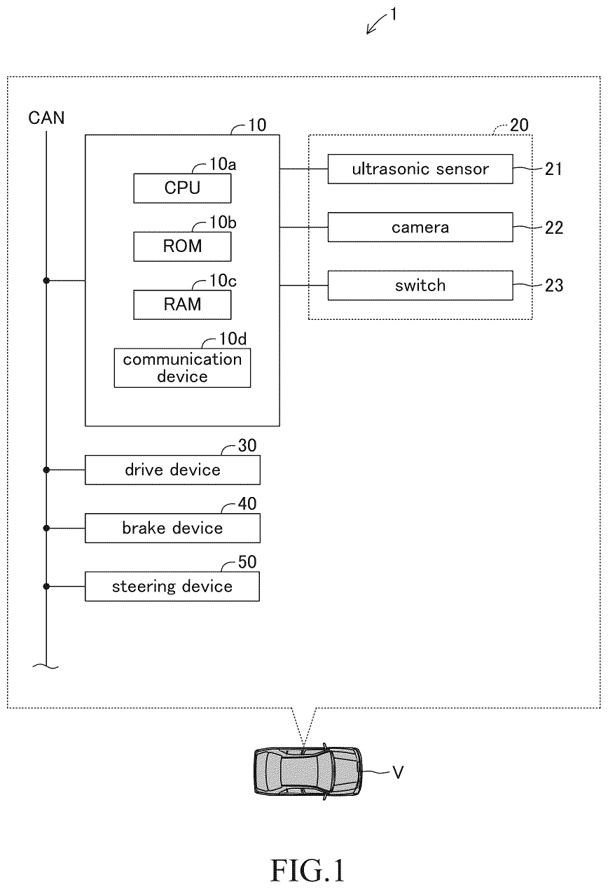

(Specific Configuration) As shown in FIG. 1, the parking assistance device 1 includes a parking assist ECU 10, an on-vehicle sensor 20, a drive device 30, a braking device 40, and a steering device 50.

The parking assist ECU 10 includes a CPU 10a, ROM 10b, RAM 10c, a timer 10d, and the like. The parking assist ECU 10 is connected to other ECUs (such as the drive device 30, braking device 40, and steering device 50 described later) via a Controller Area Network (CAN).

The on-vehicle sensor 20 includes surrounding sensors that acquire information about objects present around the own vehicle. For example, the on-vehicle sensors 20 includes an ultrasonic sensor 21 and a camera 22 as surrounding sensors.

The ultrasonic sensor 21 intermittently emits ultrasonic waves to the surrounding area of the own vehicle and receives ultrasonic waves (reflected waves) reflected by objects in the area. Based on the time from transmitting the ultrasonic waves to receiving the reflected waves, the ultrasonic sensor 21 recognizes the distance between the own vehicle and objects, the relative position (direction) of objects to the own vehicle, and the like, and sends the recognition results to the parking assist ECU 10.

The camera 22 includes an imaging device and an image analysis device. The imaging device is a digital camera equipped with an imaging element such as a CCD (charge-coupled device) or a CIS (CMOS image sensor). The imaging device is installed in the front, rear, left side, and right side of the own vehicle. The imaging device captures the surrounding area of the own vehicle at a predetermined frame rate, acquires image data for each capture, and sends the image data to the image analysis device. The image analysis device analyzes the acquired image data to obtain information about objects present around the own vehicle. For example, the image analysis device recognizes other vehicles parked in the vicinity of a parking spot PS, walls of the parking spot PS, fences, and parking lines drawn on the road surface, and sends the recognition results to the parking assist ECU 10.

Furthermore, the on-vehicle sensors 20 includes a switch 23. The switch 23 is an operating device that allows the driver to request the start of automatic parking control described later. The switch 23 includes, for example, a normally open push-button switch. The parking assist ECU 10 monitors the on/off state of the switch 23.

The drive device 30 applies traction (power) to drive wheels among the wheels (front left wheel, front right wheel, rear left wheel, and rear right wheel). The drive device 30 includes an engine ECU, an internal combustion engine, and a power transmission mechanism that transmits traction to the wheels. The internal combustion engine includes an actuator that drives a throttle valve. The engine ECU obtains information (control signals) indicating the target traction from other ECUs (parking assist ECU 10), and drives the actuator of the internal combustion engine based on the obtained information. In this way, the traction applied to the drive wheels is controlled. The traction generated by the internal combustion engine is transmitted to the drive wheels through the power transmission mechanism. The engine ECU also obtains information (control signals) regarding the shift position of the automatic transmission from other ECUs and drives the actuator of the automatic transmission based on the obtained information. In this way, the shift position of the automatic transmission is controlled.

In the case where the parking assistance device 1 is applied to a hybrid vehicle (HEV), the engine ECU can control the power of the own vehicle generated by either one or both of the “internal combustion engine and electric motor” as the own vehicle drive source. In the case where the parking assistance device 1 is applied to an electric vehicle (BEV), an electric motor ECU that controls the power of the own vehicle generated by the “electric motor” as the own vehicle drive source may be used instead of the engine ECU.

The braking device 40 applies braking force to the wheels (brake discs). The braking device 40 includes a brake ECU, brake calipers, and the like. The brake calipers include actuators that press brake pads against the brake discs. The brake ECU obtains information (control signals) indicating the target braking force from other ECUs and drives the actuator of the brake calipers based on the obtained information. In this way, the braking force applied to the wheels (brake discs) is controlled.

The steering device 50 controls the steering angle of the steering wheels (front left wheel and front right wheel). The steering device 50 includes a steering ECU, a steering mechanism, and the like. The steering device 50 further includes an actuator that drives the steering mechanism to change the steering angle. The steering ECU obtains information (control signals) indicating the target steering angle from other ECUs and drives the actuator based on the obtained information.

### (Automatic Entry Assistance Function)

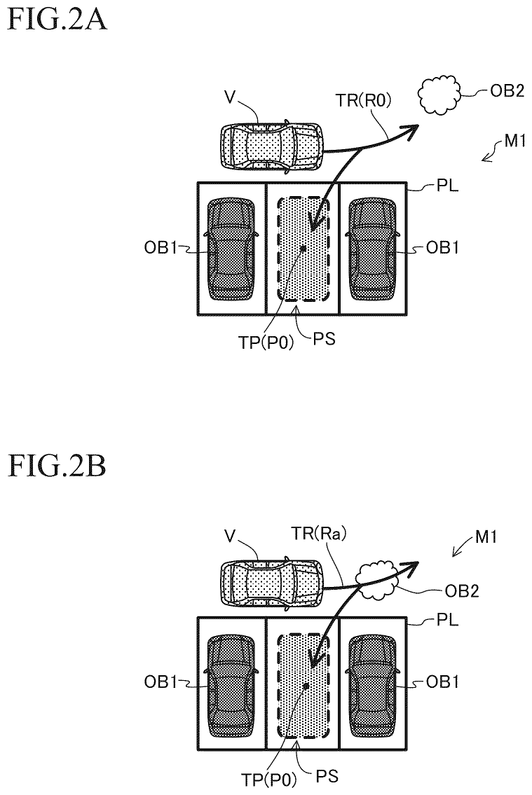

The driver stops the own vehicle near the parking spot PS (for example, an area between two other vehicles parked with a gap in the width direction, an area delimited by parking lines, etc.) where they intend to park the own vehicle, and presses switch 23. This activates the parking assist ECU 10 to start executing the program PR1, PR2, PR3 described in detail below. In other words, the parking assist ECU 10 initiates automatic parking control (parking assistance control) by automatically moving the own vehicle and parking it in the parking spot PS. Specifically, when the switch 23 is pressed, the parking assist ECU 10 detects the recognition data representing the objects present around the own vehicle obtained from the ultrasonic sensor 21 and camera 22. Based on the data obtained from the ultrasonic sensor 21 and camera 22, the parking assist ECU 10 identifies (recognizes) the parking spot PS for parking the own vehicle and generates a map M1 including the parking spot PS, as illustrated in FIG. 2. The map M1 is a two-dimensional plan view in the X-Y plane representing the position and orientation of the own vehicle in the parking spot PS. Furthermore, the map M1 includes information (three-dimensional information) representing the space occupied by objects present around the own vehicle (parking spot PS). In other words, the map M1 includes the position (e.g., center coordinates) of each object, dimensions in the X direction and Y direction, and also the dimension in the Z direction (i.e., height H).

The parking assist ECU 10 determines that an object OB1 with a height H exceeding the threshold Hth1 is an obstacle that obstructs the movement of the own vehicle. The parking assist ECU 10 also determines that an object OB2 with a height H below the threshold Hth1 and exceeding the threshold Hth2 is an object of uncertain obstruction to the movement of the own vehicle. Furthermore, the parking assist ECU 10 determines that an object with a height H below the threshold Hth2 does not obstruct the movement of the own vehicle. The threshold Hth1 is greater than the threshold Hth0 used in the obstacle determination process of conventional devices, and the threshold Hth1 is smaller than the threshold Hth0. For example, the thresholds Hth1 and Hth2 are predetermined based on the height H0 of the bottom surface of the own vehicle (the lowest part of the floor underpanel, the lowest part of the bumper cover, etc.). For example, the threshold Hth1 is approximately half the height H0. Additionally, for example, the threshold Hth2 is approximately one-fourth the height H0.

Here, since the height H of the parking lines PL drawn on the road surface is “0”, the parking assist ECU 10 generally determines that the parking lines PL do not constitute obstacles. However, as will be described later, the parking assist ECU 10 may consider the parking lines PL as obstacles in certain cases.

Next, based on the map M1, the parking assist ECU 10 sets the following position P0 as the target position TP.

(Position P0) A position where the own vehicle can be parked with a predetermined clearance provided between all objects OB1 (objects determined to be obstacles) recognized by the parking assist ECU 10 within the parking spot PS and the own vehicle (position of the own vehicle's center of gravity).

Here, the parking assist ECU 10 considers the parking lines PL as obstacles similar to object OB1 and determines the target position TP. In other words, the parking assist ECU 10 sets the target position TP to ensure that the distance between each side of the parking lines PL and each side of the own vehicle is equal to or greater than a predetermined value.

Note that there may be multiple positions P0 where the own vehicle can be stopped without encountering any of the objects OB1 within the parking spot PS. In such cases, as shown in FIG. 2A, the parking assist ECU 10 may set the target position TP to a position P0 where the front-rear positions of the front ends of adjacent other vehicles match the front-rear position of the front end of the own vehicle. If the front-rear position of the front end of the other vehicle on the left side is different from the front-rear position of the front end of the other vehicle on the right side, the parking assist ECU 10 may set the target position TP to a position P0 that aligns the front end of the own vehicle with the center of the front ends of both other vehicles. Additionally, the parking assist ECU 10 may set the target position TP to a position P0 where the distance between the own vehicle and the other vehicle on the left side is the same as the distance between the own vehicle and the other vehicle on the right side.

Next, the parking assist ECU 10 sets the following route R0 as the target route TR.

(Route R0) The shortest route that allows the own vehicle to reach the target position TP without making contact with any of the objects OB1 and OB2 recognized by the parking assist ECU 10.

Here, since the parking lines PL are generally determined as “not obstacles,” the parking assist ECU 10 determines the target route TR based on this rule, allowing the own vehicle to cross the parking lines PL.

However, in some cases, route R0 may not exist (or cannot be calculated). In such cases, the parking assist ECU 10 sets the following route Ra as the target route TR instead.

(Route Ra) The shortest route that allows the own vehicle to reach the target position TP without making contact with any of the objects OB1 recognized by the parking assist ECU 10.

In other words, as shown in FIG. 2B, the parking assist ECU 10 allows the own vehicle to pass through the region occupied by object OB2 and sets the target route TR accordingly.

The parking assist ECU 10 reflects the target position TP and target route TR in the map M1. The parking assist ECU 10 displays the map M1 on a display device. This allows the driver to confirm that the set target position TP and target route TR are appropriate. If the parking assist ECU 10 sets the route Ra as the target route TR, it notifies the driver that there is a possibility of the own vehicle making contact with the object OB2. Specifically, the parking assist ECU 10 displays the position of the object OB2 on the display and activates a buzzer.

Furthermore, in cases where a position P0 cannot be set as the target position TP (i.e., the own vehicle may make contact with one of the objects within the parking spot PS), or when route R0 cannot be set and route Ra cannot be set, the parking assist ECU 10 notifies the driver that automatic parking control cannot be executed. Specifically, the parking assist ECU 10 displays a predetermined image on the display and activates a buzzer.

Once the target position TP and target route TR are set, the parking assist ECU 10 generates a control signal pattern (a time-series data of control signals supplied to the drive device 30, brake device 40, and steering device 50, respectively) to drive the own vehicle along the target route TR. It should be noted that the parking assistance device 1 may execute (assist) only a part of the driving operations required to bring the own vehicle to the target position TP, rather than performing all the driving operations.

The parking assist ECU 10 controls the driving mechanism based on a control signal pattern to move the own vehicle along the target route TR. During the own vehicle's movement, the parking assist ECU 10 continuously acquires data representing the recognition results of objects present around the own vehicle from the ultrasonic sensor 21 and the camera 22. In the process of the own vehicle movement, the parking assist ECU 10 may newly recognize objects OB1 and/or objects OB2 that were not recognized at the start time t0 of automatic parking control. In such a case, the parking assist ECU 10 updates the target position TP and/or the target route TR.

Specifically, when the parking assist ECU 10 newly recognizes an object within the parking spot PS, it reconfigures the target position TP to the following position Pa.

(Position Pa) A position where the own vehicle can be parked with a predetermined clearance provided between all objects OB1 and all objects OB2 within the parking spot PS as recognized by the parking assist ECU 10 at time t1.

As described above, at the start time t0 of automatic parking control, the recognition accuracy of objects within the parking spot PS is not very high. Therefore, at time t0, the parking assist ECU 10 excludes object OB2 and treats object OB1 as an obstacle when setting the target position TP. However, as the own vehicle progresses from time t0 and the recognition accuracy of objects within the parking spot PS improves, at time t1, the parking assist ECU 10 updates the target position TP, considering both objects OB1 and objects OB2 as obstacles.

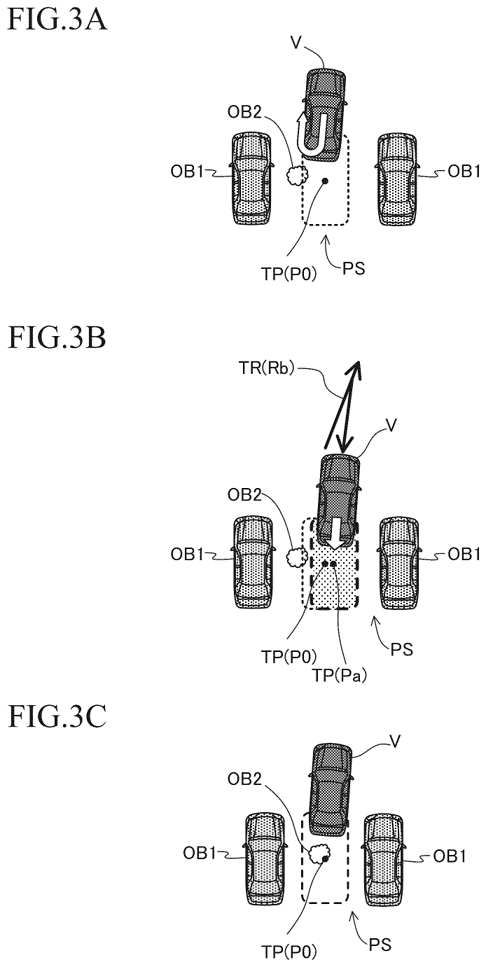

For example, as shown in FIG. 3A, the parking assist ECU 10 may newly recognize object OB2 within the parking spot PS. In this example, the clearance between the adjacent two other vehicles is relatively wide. Therefore, even if the target position TP is shifted to the right in the figure to avoid object OB2, a predetermined clearance can still be ensured around the own vehicle. Thus, in this case, as shown in FIG. 3B, the parking assist ECU 10 changes the target position TP from position P0 to position Pa.

On the other hand, as shown in FIG. 3C, if position Pa cannot be set (i.e., the own vehicle would contact any of the objects within the parking spot PS), the parking assist ECU 10 notifies the driver that automatic parking control cannot be executed, and terminates the automatic parking control.

When the parking assist ECU 10 updates the target position TP or newly recognizes objects within the current target route TR, it reconfigures the following route Rb as the target route. TR:

(Route Rb) The shortest route that allows the own vehicle to reach the target position TP without contacting any of the objects OB1 and objects OB2 recognized by the parking assist ECU 10 at time t1.

If the route Rb cannot be set and the target route TR cannot be updated, the parking assist ECU 10 reconfigures the following route Rc as the target route TR.

(Route Rc) The shortest route that allows the own vehicle to reach the target position TP without contacting any of the objects OB1 recognized by the parking assist ECU 10 at time t1.

In this case, the parking assist ECU 10 notifies the driver of the possibility of the own vehicle contacting object OB2. If neither route Rb nor route Rc connot be set, the parking assist ECU 10 notifies the driver that automatic parking control cannot be executed, and terminates the automatic parking control.

When the parking assist ECU 10 updates the target position TP and/or the target route TR, it updates the control signal pattern accordingly. Then, the parking assist ECU 10 controls the drive device etc. to move the own vehicle based on the updated control signal pattern.

Once the own vehicle reaches the target position TP, the parking assist ECU 10 parks (stops) the own vehicle. That is, the parking assist ECU 10 changes the shift position to the parking position, activates the parking brake, and transitions the ignition switch to the off state.

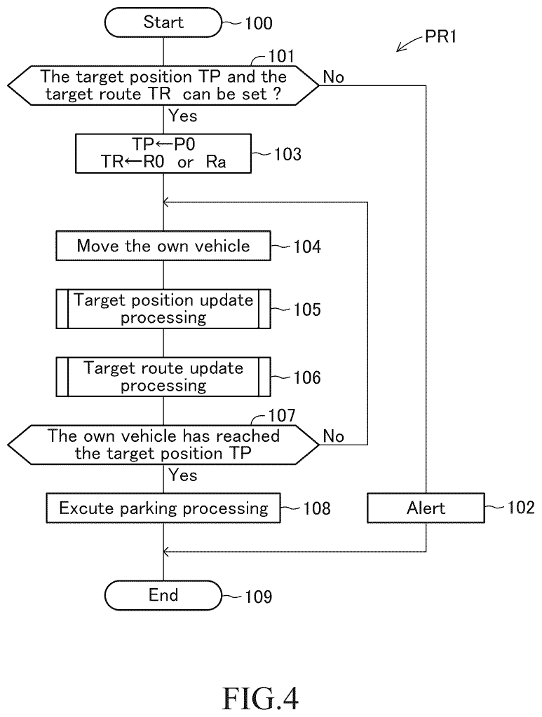

Next, referring to FIG. 4 to 6, the processing (Program PR1 and its subroutines Program PR2, PR3) executed by the CPU 10a of the parking assist ECU 10 (referred to as “CPU” hereinafter) will be described in detail.

When the CPU detects that the switch 23 has been pressed, the CPU starts executing Program PR1 from step 100 and proceeds to step 101.

At step 101, the CPU determines whether it is possible to set the target position TP and the target route TR. If it is possible to set the target position TP and the target route TR (101: Yes), the CPU proceeds to step 103. On the other hand, if it is not possible to set the target position TP and/or the target route TR (101: No), the CPU proceeds to step 102.

When the CPU proceeds to step 102, it notifies the driver that automatic parking control cannot be executed, proceeds to step 109, and ends the execution of Program PR1.

When the CPU proceeds to step 103, it sets the position P0 as the target position TP. Additionally, the CPU sets the route R0 as the target route TR. However, if the route R0 cannot be set, the CPU sets the route Ra as the target route TR. In this case, the CPU notifies the driver of the possibility of the own vehicle contacting object OB2. Then, the CPU proceeds to step 104.

When the CPU proceeds to step 104, it controls the drive device etc. to move the own vehicle a small distance Δd along the target route TR.

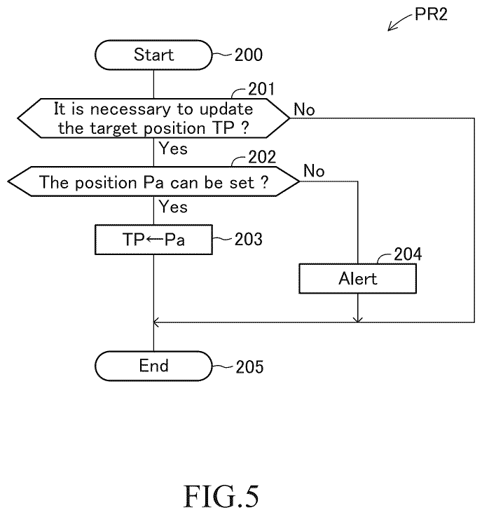

When the CPU proceeds to step 105, it starts executing Program PR2 (target position update processing) shown in FIG. 5.

When the CPU starts executing Program PR2 from step 200, it proceeds to step 201.

When the CPU proceeds to step 201, it determines whether it is necessary to update the target position TP. The CPU determines that the target position TP needs to be updated if it has newly recognized objects within the parking spot PS. If it is determined that the target position TP needs to be updated (201: Yes), the CPU proceeds to step 202. On the other hand, if the CPU determines that the target position TP does not need to be updated (201: No), it proceeds to step 205.

When the CPU proceeds to step 202, it determines whether the position Pa can be set or not. If the position Pa can be set (202: Yes), the CPU proceeds to step 203. On the other hand, if the position Pa cannot be set (202: No), the CPU proceeds to step 204.

When the CPU proceeds to step 203, it sets the position Pa as the target position TP. Then, the CPU proceeds to step 206.

When the CPU proceeds to step 204, it notifies the driver that automatic parking control cannot be executed and proceeds to step 205.

When the CPU proceeds to step 205, it ends the execution of Program PR2 and proceeds to step 106 of Program PR1 (FIG. 4).

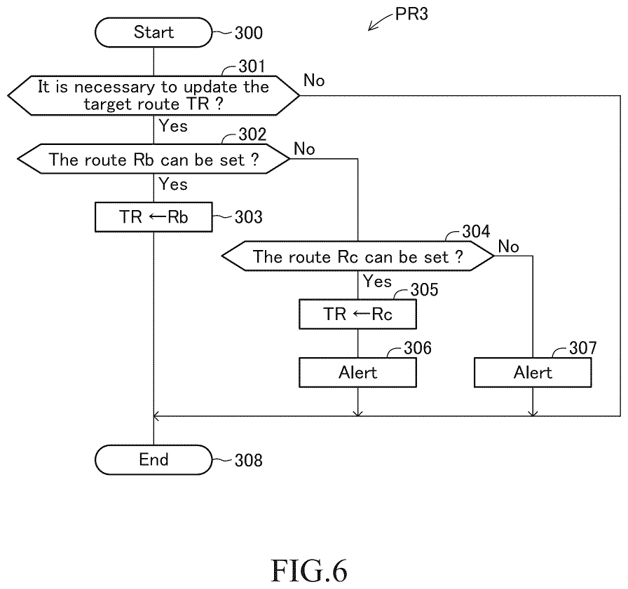

The CPU proceeds to step 106 and starts executing program PR3 (Target Route Update Processing) shown in FIG. 6.

When the CPU starts executing program PR3 from step 300, it proceeds to step 301.

When the CPU proceeds to step 301, the CPU determines whether it is necessary to update the target route TR. If the CPU has updated the target position TP during the execution of step 205 (program PR2), it determines that it is necessary to update the target route TR. Additionally, if the CPU recognizes an object located within the current target route TR, it determines that it is necessary to update the target route TR. If the CPU determines that it is necessary to update the target route TR (301: Yes), it proceeds to step 302. On the other hand, if the CPU determines that it is not necessary to update the target route TR (301: No), it proceeds to step 308.

When the CPU proceeds to step 302, the CPU determines whether a route Rb can be set or not. If a route Rb can be set (302: Yes), the CPU proceeds to step 303. Conversely, if a route Rb cannot be set (302: No), the CPU proceeds to step 304.

When the CPU proceeds to step 303, the CPU sets a route Rb as the target route TR and proceeds to step 308.

When the CPU proceeds to step 304, the CPU determines whether a route Rc can be set or not. If a route Rc can be set (304: Yes), the CPU proceeds to step 305. Conversely, if a route Rc cannot be set (304: No), the CPU proceeds to step 307.

When the CPU proceeds to step 305, the CPU sets a route Rc as the target route TR and proceeds to step 306.

When the CPU proceeds to step 306, the CPU notifies the driver that there is a possibility of the own vehicle coming into contact with marker OB2. Then, the CPU proceeds to step 308.

When the CPU proceeds to step 307, the CPU notifies the driver that the automatic parking control cannot be executed. Then, the CPU proceeds to step 308.

When the CPU proceeds to step 308, the CPU finishes the execution of program PR3 and proceeds to step 107 of program PR1 (FIG. 4).

When the CPU proceeds to step 107, the CPU determines whether the own vehicle has reached the target position TP. If the own vehicle has reached the target position TP (107: Yes), the CPU proceeds to step 108. On the other hand, if the own vehicle has not yet reached the target position TP (107: No), the CPU returns to step 104.

When the CPU proceeds to step 108, the CPU performs parking processing. Specifically, the CPU stops the own vehicle, changes the shift position to the parking position, activates the parking brake, and transitions the ignition switch to the off state. Then, the CPU proceeds to step 109 and finishes the execution of program PR1.

### (Automatic Exit Assistance Function)

When the parking assist ECU 10 detects that the switch 23 has been pressed while the own vehicle is parked in the parking spot PS, it initiates automatic exit control similar to automatic entry control. That is, based on the information obtained from the on-vehicle sensor 20, the parking assist ECU 10 searches for a temporary stopping area near the parking spot PS, where the own vehicle can be temporarily stopped. Then, the parking assist ECU 10 sets the target position TP within the temporary stopping area and the target route TR. Subsequently, the parking assist ECU 10 moves the own vehicle along the target route TR from the parking spot PS. If the parking assist ECU 10 recognizes new objects during the movement of the own vehicle, it updates the target position TP and/or the target route TR.

### Effect

The parking assist ECU 10 can set a target route TR, namely route R0 (Rb), that allows reaching the target position TP without coming into contact with object OB2, which is determined to be an obstacle with unknown certainty, in addition to object OB1 determined to be an obstacle. Therefore, the parking assist device 1 can improve the safety during entry and exit compared to conventional devices that may incorrectly determine object OB2 as a non-obstacle.

It should be understood that the present invention is not limited to the above embodiments and various modifications can be made within the scope of the invention.

In the above embodiments, the parking assist ECU 10 acquires the height of each object as a physical quantity for obstacle determination. However, the parking assist ECU 10 may acquire other physical quantities in addition to or instead of the height of each object as a physical quantity for obstacle determination. For example, the parking assist ECU 10 may consider the gradient of the road surface where each object is located and acquire the height of each object accordingly.

What is claimed is:

1. A parking assistance device assisting an operation to park an own vehicle in a parking spot, and/or an operation to exit the own vehicle from the parking spot, comprising:
a surrounding sensor to acquire information about objects existing around the own vehicle; and
a processor capable of executing parking assistance control to assist driving operation by the driver, by setting a target position based on the information acquired by the surrounding sensor, further setting a target route to reach the target position, and controlling the own vehicle to automatically move along the target route and reach the target position, wherein
the processor is configured to set the target route as a route that can reach the target position without making contact with all the first objects, which are determined to obstruct the progress of the own vehicle, and all the second objects, which are determined to be unclear whether or not they obstruct the progress of the own vehicle.

2. The parking assistance device according to claim 1, wherein if there is no route that allows the own vehicle to reach the target position without contacting any of the first objects and any of the second objects, the processor is configured to set the target route as the route that enables the own vehicle to reach the target position without contacting any of the first objects, and allows the own vehicle to pass through an area occupied by one or more of the second objects.

3. The parking assistance device according to claim 2, further comprising a presentation unit that presents information indicating that the own vehicle is expected to pass through an area occupied by the second objects to the occupant of the own vehicle.

4. The driving assistance device according to claim 1, wherein
the processor is configured to set the target position based on the front end position of another vehicle parked adjacent to the parking spot when the other vehicle is parked parallel to the own vehicle.

5. A parking assistance method for assisting an operation to park an own vehicle in a parking spot, and/or an operation to exit the own vehicle from the parking spot, comprising;
an information acquisition step to acquire information about objects existing around the own vehicle, and
a parking assistance step to assist the driving operation by the driver, by setting a target position based on the information acquired by the surrounding sensor, further setting a target route to reach the target position, and controlling the own vehicle to automatically move along the target route and reach the target position, wherein
the parking assistance step includes a step to set the target route as a route that can reach the target position without making contact with all the first objects, which are determined to obstruct the progress of the own vehicle, and all the second objects, which are determined to be unclear whether or not they obstruct the progress of the own vehicle.
